(19) United States
(12) Patent Application Publication
(10) Pub. No.: US 2013/0086306 A1
(43) Pub. Date: Apr. 4, 2013

(54) INFORMATION PROCESSOR AND MEMORY MANAGEMENT METHOD

(71) Applicant: Satoshi Yamauchi, Tachikawa-shi (JP)

(72) Inventor: Satoshi Yamauchi, Tachikawa-shi (JP)

(21) Appl. No.: 13/448,833

(22) Filed: Apr. 17, 2012

(30) Foreign Application Priority Data
Sep. 30, 2011 (JP) 2011-217741

(51) Int. Cl. G06F 12/02

(52) U.S. Cl. 711/103; 711/165; 711/E12.002; 711/E12.008

(57) ABSTRACT

According to one embodiment, an information processor includes: a controller, a volatile storage module, a non-volatile storage module, and a reader. The volatile storage module is configured to be allocated with a storage area which can be accessed by the controller. The non-volatile storage module is configured to save data stored in the storage area of the volatile storage module at transition to a power-off state. The reader is configured to read, if a state just prior to the transition to the power-off state is to be recovered, the data stored in the non-volatile storage module by each page, and to load the read data to the storage area in the volatile storage module. The page is configured by a plurality of memory cells.

### CROSS-REFERENCE TO RELATED APPLICATIONS

This application is based upon and claims the benefit of priority from Japanese Patent Application No. 2011-217741, filed Sep. 30, 2011, the entire contents of which are incorporated herein by reference.

### FIELD

Embodiments described herein relate generally to an information processor and a memory management method.

### BACKGROUND

Conventionally, there is known some information processors such as a personal computer (PC) with a hibernation function. In such information processors, operation contents stored in a physical memory (volatile memory), such as data of an operating system (OS) or various application programs being executed by a central processing unit (CPU), are saved into a non-volatile memory before turning off a power (before shutdown). Then, when the PC is rebooted, the data saved in the non-volatile memory is read to the volatile memory so as to be able to recover a state right before the PC shutdown.

For such hibernation function, it has been desired to reduce a boot time during which the data saved in the non-volatile memory is read into the volatile memory to recover the state right before the power-off. In other words, it has been desired to speed up the recovering operation.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of an information processor according to an embodiment;

FIG. 2 is an exemplary conceptual schematic diagram of storage areas in a volatile memory and storage areas in a non-volatile memory in the embodiment; and

FIG. 3 is an exemplary flowchart of an operation performed by the information processor in the embodiment.

### DETAILED DESCRIPTION

In general, according to one embodiment, an information processor comprises: a controller; a volatile storage module; a non-volatile storage module; and a reader. The volatile storage module is configured to be allocated with a storage area which can be accessed by the controller. The non-volatile storage module is configured to save data stored in the storage area of the volatile storage module at transition to a power-off state. The reader is configured to read, if a state just prior to the transition to the power-off state is to be recovered, the data stored in the non-volatile storage module by each page, and to load the read data to the storage area in the volatile storage module. The page is configured by a plurality of memory cells.

An information processor and a memory management method according to an embodiment will now be explained in detail with reference to the accompanying drawings. In this embodiment, a general personal computer is used as an example of the information processor. However, it should be needless to say that such an embodiment is applicable to any device having a hibernation function, such as a digital television or a hard disk recorder.

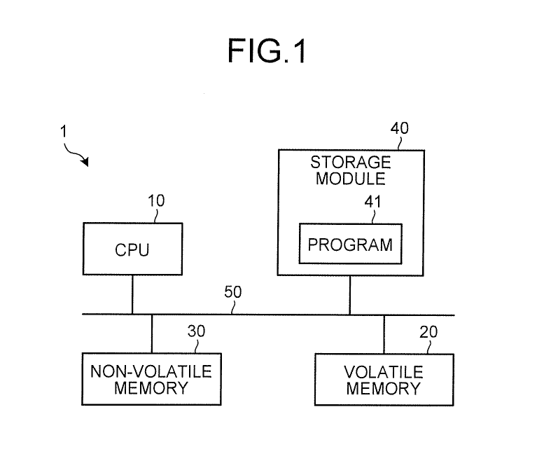

FIG. 1 is a block diagram illustrating a configuration of an information processor 1 according to the embodiment. As illustrated in FIG. 1, the information processor 1 comprises a central processing unit (CPU) 10, a volatile memory 20, a non-volatile memory 30, and a storage module 40 that are connected to each other via a bus 50.

The CPU 10 is a processor that centrally controls operations of the information processor 1. The CPU 10 loads a program 41 such as an operating system (OS) and various application programs stored in the storage module 40 to the volatile memory 20, and executes the program 41 sequentially to control the operations of the information processor 1. The CPU 10 is usually configured as a general purpose processor, but may also be configured as a large scale integration (LSI) circuit, an application specific integrated circuit (ASIC), and the like that is a special purpose semiconductor processor. The CPU 10 may also be configured as a field programmable gate array (FPGA) that is a reconfigurable processor, or a dynamically reconfigurable processor. The CPU 10 may be configured as a multi-core processor comprising a plurality of cores, or may be installed in plurality in the information processor 1.

The volatile memory 20 is a physical memory allocated with storage areas (memory spaces) that are made available for accesses to the CPU 10. The volatile memory 20 is configured as a so-called volatile storage medium, and data stored in the volatile memory 20 is lost when the power supply is stopped. The volatile memory 20 is configured as a static random access memory (SRAM) or a dynamic random access memory (DRAM), for example.

The non-volatile memory 30 is configured as a so-called non-volatile storage medium for realizing the hibernation function, and data stored in the non-volatile memory 30 is not to be lost even when the power supply is stopped. For example, the non-volatile memory 30 is configured as a hard disk drive (HDD) that is a magnetic storage medium, or a NOR flash memory, a NAND flash memory, and a solid state drive (SSD) that are semiconductor storage media.

In this embodiment, the non-volatile memory 30 is a NAND flash memory. The NAND flash memory has a structure in which a plurality of memory cells each storing therein one-bit of information are connected to a lead wire that is required for driving. Therefore, in a NAND flash memory, the time required in reading or writing one-bit of data from or to a single memory cell is equal to the time required in reading or writing data by each page comprising a plurality of memory cells which are driven in a shared manner.

At a time of transition to a power-off state, the data stored in the storage areas in the volatile memory 20 is saved (copied) to the non-volatile memory 30. To recover the state just prior to the transition to the power-off state, the CPU 10 as a reader reads the data stored in the non-volatile memory 30 by each page, and loads the read data to the storage areas in the volatile memory 20. In this manner, by reading the data stored in the non-volatile memory 30 efficiently by each unit, it is possible to speed up resuming from hibernation.

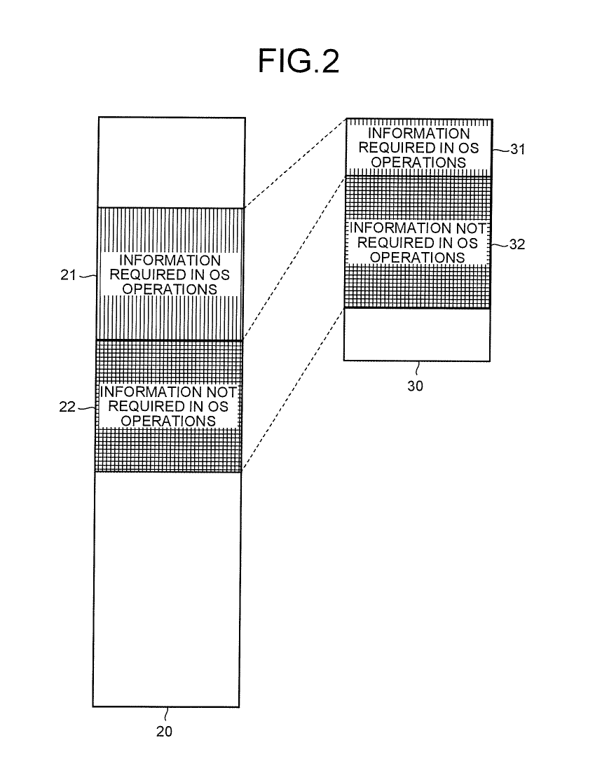

FIG. 2 is a conceptual schematic diagram illustrating storage areas in the volatile memory 20 and storage areas in the non-volatile memory 30. As illustrated in FIG. 2, the volatile memory 20 comprises: a storage area 21 reserved for storing therein OS images that are information required in OS operations; and a storage area 22 reserved for storing therein information for application programs and the like operating on the OS and not required in the OS operations. The OS images comprise a kernel that is a central component, services (so-called daemons) for managing kernel functions and functions executed by the information processor 1 using the kernel functions, process management information related to process management, and memory management information for managing the mapping relationship between a virtual address of the volatile memory 20 in a memory space and a physical address in the volatile memory 20.

At the transition to the power-off state, the CPU 10 saves the data stored in the storage area 21 in the volatile memory 20 to a storage area 31 reserved sequentially from the top address in the non-volatile memory 30. The CPU 10 then saves the data stored in the storage area 22 in the volatile memory 20 to a storage area 32 reserved next to the storage area 31. The data may be compressed before being saved in the non-volatile memory 30 from the volatile memory 20. When the data stored in the storage area 21 and the storage area 22 in the volatile memory 20 is respectively saved to the storage area 31 and the storage area 32 in the non-volatile memory 30, information indicating the relationship between the source address and the destination address is assigned to the memory management information mentioned earlier.

When the state just prior to the transition to the power-off state is to be recovered with power supplied to the information processor 1, for example, the CPU 10 reads the data from the top address in the non-volatile memory 30, and loads the data (OS images) stored in the storage area 31 to the volatile memory 20. The CPU 10 then reads the data stored in the storage area 32, and loads the data to the volatile memory 20. Once the OS images stored in the storage area 31 are loaded to the volatile memory 20, the CPU 10 starts running the OS. Therefore, when a read request is issued by the CPU 10 while the data stored in the storage area 32 is being loaded to the volatile memory 20 after the OS is started running, the CPU 10 refers to the memory management information, thereby reading the page storing therein the data requested by the read request from the storage area 32 and loading the data to the volatile memory 20. In this manner, while the data is being read from the non-volatile memory 30 after the OS is started running, the CPU 10 reads the page storing therein data requested by the read request issued by the CPU 10 on-demand. Therefore, it is possible to speed up the operations performed after the OS is started running.

Referring back to FIG. 1, the storage module 40 is a storage device such as a read-only memory (ROM) or a hard disk drive (HDD), and stores therein the program 41 executed by the CPU 10, various setting data, and the like. The program 41 may be a computer program related to the OS, a booting program for reading the OS images stored in the non-volatile memory 30 when the operations are to be resumed by the hibernation function, or various application programs.

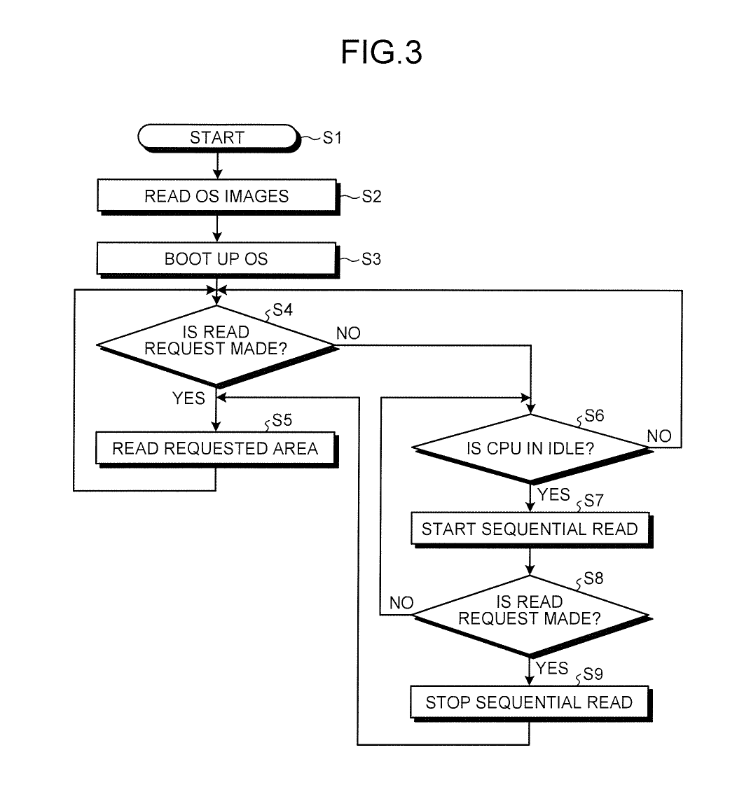

The operation performed by the information processor 1 to realize the hibernation function for resuming the state just prior to transiting to the power-off state will now be explained in detail. FIG. 3 is a flowchart illustrating an example of the operation performed by the information processor 1 in the embodiment.

As illustrated in FIG. 3, when the power is turned on by a powering instruction made via an operation module (not illustrated) such as a power switch, the CPU 10 reads the booting program, and starts a process related to the hibernation function (S1). Once the process is started at S1, the CPU 10 reads the OS images stored in the storage area 31 in the non-volatile memory 30 (S2). The CPU 10 then loads the OS images thus read to the volatile memory 20, and starts running the OS (S3). In this manner, the CPU 10 becomes able to access the volatile memory 20 according to an OS process.

The CPU 10 then determines if a read request for reading data from the storage area 22 in the volatile memory 20 has been made according to the OS process (S4). The CPU 10 determines if the data to be read is stored in the storage area 22 by referring to the memory management information. If the read request has been made for the data stored in the storage area 22 in the volatile memory 20 (Yes at S4), because the data is not yet loaded from the storage area 32 in the non-volatile memory 30 to the storage area 22 in the volatile memory 20, the CPU 10 refers to the memory management information, reads the page storing therein the data requested by the read request from the storage area 32, and loads the page to the volatile memory 20 (S5).

If no read request for reading data from the storage area 22 in the volatile memory 20 has been made (No at S4), the CPU 10 further determines if the system is in an idle state in which the volatile memory 20 is not accessed (S6). If the system is not in the idle state (No at S6), the CPU 10 returns the process to S4.

If the system is in the idle state (Yes at S6), the CPU 10 starts reading data stored in the storage area 32 in the non-volatile memory 30 but not yet loaded to the volatile memory 20 by sequential reading in which the data is read from a page in sequence with a page previously read and the data thus read is loaded to the volatile memory 20 (S7). Specifically, the CPU 10 maintains information indicating the page read from the non-volatile memory 30 as a stack, for example, in the storage area 21 in the volatile memory 20, and reads the data by referring to such information and designating the page in sequence with such a page. By performing the sequential reading, data can be read efficiently at a high speed from the non-volatile memory 30. If the non-volatile memory 30 does not support the sequential reading, the data may be read from a page located near the page previously read. In an example in which the data from a page located near the page read previously, the data can be read efficiently at a high speed from the non-volatile memory 30.

The CPU 10 then determines if a read request for requesting data from the storage area 22 in the volatile memory 20 has been made according to the OS process (S8). If no read request has been made (No at S8), the CPU 10 returns the process to S6. Therefore, if the CPU 10 is in the idle state, and no read request has been made according to the OS process, the sequential read started at S7 is continued. Therefore, the sequential read enables the data stored in the storage area 32 in the non-volatile memory 30 to be loaded to the storage area 22 in the volatile memory 20 at a high speed.

If a read request is being made (Yes at S8), the CPU 10 stops the sequential read started at S7 (S9), and proceeds the process to S5 to read the page storing therein the data requested by the read request.

The CPU 10 continues performing the processes at S4 to S9 described above until all of the data stored in the storage area 32 in the non-volatile memory 30 is loaded to the storage area 22 in the volatile memory 20. The processes at S1 to S9 described above enable the information processor 1 to recover (resume) the state just prior to the transition to the power-off state.

In the configuration explained in this embodiment, the CPU 10 functions as a reader that reads data saved to the non-volatile memory 30, according to the program 41 such as the booting program and the OS, and loads the data thus read to the volatile memory 20. However, the reader may also be a microcontroller, for example, as a controller other than the CPU 10 for controlling reading data from the non-volatile memory 30.

The program 41 executed by the information processor 1 according to the embodiment is provided in a manner stored in the ROM and the like in advance. The program 41 executed by the information processor 1 according to the embodiment may also be configured to be provided in a manner recorded in a computer-readable recording medium such as a compact disk read-only memory (CD-ROM), a flexible disk (FD), a CD recordable (CD-R), and a digital versatile disk (DVD) as a file in an installable or executable format.

Furthermore, the program 41 executed by the information processor 1 according to the embodiment may be configured to be provided in a manner stored in a computer connected to a network such as the Internet, and being made available for download over the network. Furthermore, the program 41 executed by the information processor 1 according to the embodiment may be provided or distributed over a network such as the Internet.

The program 41 executed by the information processor 1 according to the embodiment has a modular structure comprising the functions described above. As actual hardware, the functions described above are loaded to and generated on a main memory by causing a CPU (processor) to read the program 41 from the ROM and to execute the program 41.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a controller;
a volatile storage module configured to be allocated with a storage area which can be accessed by the controller;
a non-volatile storage module configured to save data stored in the storage area of the volatile storage module at transition to a power-off state; and
a reader configured to read, if a state just prior to the transition to the power-off state is to be recovered, the data stored in the non-volatile storage module by each page, and to load the read data to the storage area in the volatile storage module, the page being configured by a plurality of memory cells.

2. The information processor of claim 1, wherein, if a read request for data is made by the controller after data related to an operating system (OS) is loaded to the storage area of the volatile memory module, the reader is configured to read a page storing therein the data for which the read request is made.

3. The information processor of claim 1, wherein the reader is configured to read the data from a page located near a page read previously.

4. The information processor of claim 3, wherein the reader is configured to read the data stored in the non-volatile storage module by sequential reading in which the data is read from a page in sequence with a page read previously.

5. The information processor of claim 4, wherein the reader is configured to read the data stored in the non-volatile storage module by the sequential reading if the controller is in an idle state.

6. The information processor of claim 4, wherein, if the read request for data is made by the controller while data stored in the non-volatile memory module is read by the sequential reading, the reader is configured to stop the sequential reading and to read a page storing therein data for which the read request is made.

7. The information processor of claim 1, wherein the non-volatile storage module is a NAND flash memory.

8. The information processor of claim 7, wherein the reader is configured to read the data stored in the NAND flash memory by each page, and to load the read data to the storage area in the volatile storage module, the page comprising a plurality of memory cells which are driven in a shared manner.

9. A memory management method for an information processor that comprises a controller, a volatile storage module configured to be allocated with a storage area which can be accessed by the controller, and a non-volatile storage module configured to save data stored in the storage area of the volatile storage module at transition to a power-off state, the memory management method comprising:
reading, if a state just prior to the transition to the power-off state is to be recovered, the data stored in the non-volatile storage module by each page, and loading the read data to the storage area in the volatile storage module, the page being configured by a plurality of memory cells.
